(19) United States
(12) Patent Application Publication
(10) Pub. No.: US 2026/0118095 A1
(43) Pub. Date: Apr. 30, 2026

(54) MODULAR FLUID CANISTER UNIT FOR AUTONOMOUS DETERRENT ROBOTS

(71) Applicants: Ching-Tien Ho, San Jose, CA (US); David Fong, Sunnyvale, CA (US); Redem Chiang, Saratoga, CA (US)

(72) Inventors: Ching-Tien Ho, San Jose, CA (US); David Fong, Sunnyvale, CA (US); Redem Chiang, Saratoga, CA (US)

(73) Assignee: Agape-1 Technology Inc., San Jose, CA (US)

(21) Appl. No.: 19/349,660

(22) Filed: Oct. 3, 2025

Related U.S. Application Data
(60) Provisional application No. 63/711,837, filed on Oct. 25, 2024.

(51) Int. Cl. F41H 9/00; A61D 7/00

(52) U.S. Cl. CPC F41H 9/00; A61D 7/00

(57) ABSTRACT

A mobile security robot system is disclosed comprising a robot vehicle with pressurized fluid canisters, rotatable spray mechanisms, and a software control system for sensor-based or operator-triggered activation. An integrated invisible ink application module enables covert suspect tagging, while an automated refill interface allows docking with a fluid station for replenishment. The system provides non-lethal deterrence, evidence gathering, and optional environmental uses including plant hydration and wildlife deterrence.

### CROSS-REFERENCE TO RELATED APPLICATIONS

This application claims the benefit of U.S. Provisional Application No. 63/711,837, filed on Oct. 25, 2024. The disclosure of the above application is incorporated herein by reference.

### FIELD

The present invention relates to modular fluid canister units for integration with autonomous robots.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Advancements in robotics and security technologies have led to the development of autonomous security systems, but existing solutions often lack effective deterrence or dynamic responses to evolving threats.

Previous inventions have described various types of autonomous security robots. For example, the Mannequin Robot Patent (U.S. patent application Ser. No. 18/661,714) discloses mobile security robots with autonomous navigation. The Crime Detection System Patent (U.S. patent application Ser. No. 19/060,805) describes AI-based threat identification. The Robotic Arm and Water Cannon Patent (U.S. patent application Ser. No. 19/172,536) introduces cost-effective deterrence involving robotic arms and water cannons. Building upon these prior developments, the present disclosure further improves security robot capabilities by integrating commodity fluid canisters for deterrence, automated refilling mechanisms, and optional invisible ink tracking.

### SUMMARY

The invention describes a modular canister unit attachable to mobile robots for fluid-based deterrence and tagging. The unit includes a pressurized container, rotatable nozzle assembly, motorized actuator, and an optional ink injection interface. Integrated sensors provide proximity detection, while a standardized connector enables quick attachment, refilling, and signal transfer. The modular design supports rapid replacement, hot-swappability, and scalable deployment across multiple robot platforms.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

Note: Although certain figures and labels refer to “water canisters” or “water level,” such terminology is illustrative only and should be understood to encompass fluid canisters, fluid levels, or equivalent fluid-based systems as described herein.

FIG. 1 is a schematic diagram illustrating a mobile security robot system with integrated fluid canisters, rotating nozzles, and an optional invisible ink application module.

FIG. 2 is a detailed view of a modular fluid canister unit showing the spray nozzle, actuator mechanism, and optional ink injector.

FIGS. 3A and 3B are top-down diagrams showing different spray coverage configurations based on the mounting positions of fluid canisters on the robot chassis.

FIGS. 4A and 4B illustrate an automated refilling system, including docking interfaces and fluid transfer configurations for both centralized and independent canister storage models.

FIG. 5 is a two-phase conceptual diagram depicting the lifecycle of invisible ink deployment and post-incident detection using UV or IR scanning.

FIG. 6 is a system flowchart showing the operational logic of the robot, including threat detection, spray activation, event logging, and refilling.

FIG. 7 illustrates an environmental spraying use case in which the robot hydrates vegetation, cools animals, or deters wildlife in agricultural and residential environments.

### DETAILED DESCRIPTION

The following description is merely exemplary in nature and is in no way intended to limit the disclosure, its application, or uses. For purposes of clarity, the same reference numbers with or without a single or multiple prime symbols appended thereto will be used in the drawings to identify similar elements. It should be understood that steps within a method may be executed in different order without altering the principles of the present disclosure unless otherwise specified.

Overview: The invention involves a security robot system utilizing pressurized fluid canisters to deter threats, with features like adjustable spray mechanisms, automated refilling, and the integration of invisible ink for tracking. These components work together to provide an effective and versatile security solution.

In addition to its use in security and deterrence against human intruders, the system may be adapted for agricultural and environmental applications. In such embodiments, the mobile robot vehicle autonomously patrols outdoor areas such as orchards, crop fields, golf courses, or residential lawns, using its pressurized canisters to hydrate vegetation or to cool animals during periods of heat stress. The same spray system may also serve as a non-lethal means of deterring wild animals from entering protected areas, such as farms, pet enclosures, or human-inhabited zones.

Terminology note: In the figures and associated captions, certain components are labeled using terms such as “water canister,” “water reservoir,” or “water supply line.” These labels are provided for illustrative convenience and are not intended to limit the scope of the disclosure. Unless otherwise specified, such references should be understood to encompass fluid canisters, fluid reservoirs, fluid supply lines, or other fluid-based systems generally. The fluids may include, without limitation, water, invisible ink solutions, deterrent mixtures, or other liquids suitable for the embodiments described herein.

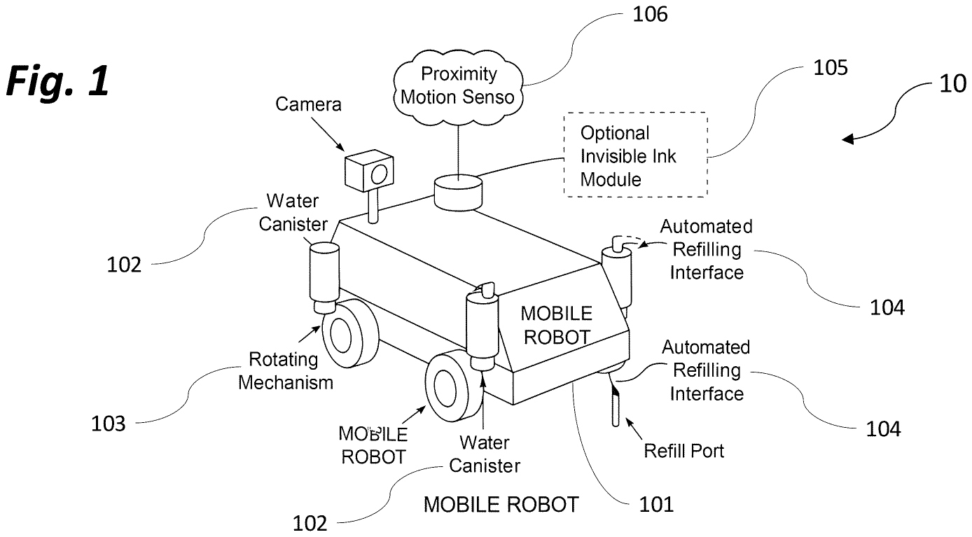

### FIG. 1—System Overview

Referring Now to FIG. 1 (block 10). It Illustrates a Schematic overview of the mobile robot system, which includes a mobile platform, multiple pressurized fluid canisters, rotating spray mechanisms, a software control unit, an optional invisible ink application module, and a vision system.

Mobile Robot Vehicle (Block 101): The autonomous chassis responsible for locomotion, navigation, and supporting all mounted components.

Pressurized Fluid Canisters (Block 102): Cylindrical containers used to store water or fluid mixtures for deterrent purposes.

Rotating Mechanisms (Block 103): Motorized units attached to each canister that adjust nozzle orientation for directional spraying.

Refilling Interface (Block 104): A port located on the side or rear of the robot used for automatic docking and fluid replenishment.

Invisible Ink Module (Block 105): An optional component integrated with the spray system that injects UV-or IR-reactive ink into the fluid stream.

Proximity Sensors (Block 106): Embedded motion detectors used to identify nearby threats.

Camera (block 107): a Vision System Mounted Atop the Robot for surveillance, image capture, and target tracking.

In addition to the components shown in FIG. 1, a Software Control System, though not explicitly illustrated, may be implemented as an onboard processing unit housed within the mobile robot vehicle. This control system is responsible for interpreting sensor input, initiating canister discharge routines, coordinating spray direction, and managing automated refill operations.

### 1. Pressurized Fluid Canisters

The security robot is equipped with pressurized fluid canisters strategically mounted on the vehicle to maximize coverage of the surrounding area. The canisters are positioned at key locations on the robot to ensure effective coverage without obstructing mobility or sensor operation. This strategic placement is crucial for optimizing the deterrent spray.

Spray Mechanism: Each canister is fitted with a rotating mechanism that allows for adjustable spray angles, ensuring flexible coverage. The rotation can be controlled by servo or stepper motors, which provide precise control over the direction and pattern of the spray. Adjustable nozzles enable the system to produce a mist for wider coverage or a focused jet for targeted deterrence.

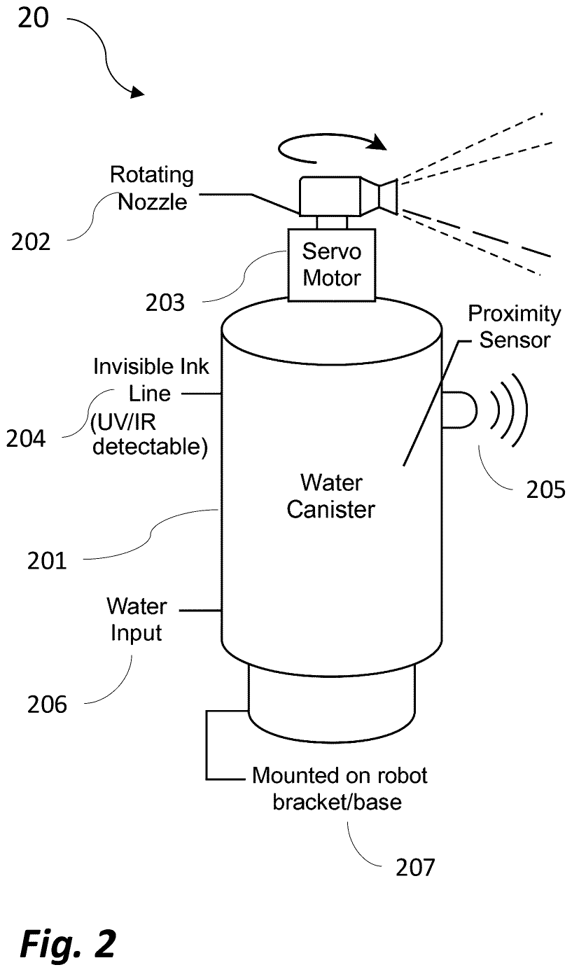

### FIG. 2—Canister Detail

FIG. 2 (Block 20) provides a close-up view of the modular fluid canister assembly, illustrating nozzle configuration, motion control, and optional ink injection.

Fluid Canister (block 201): a Standalone Vessel Mounted to the robot frame, designed for detachable use or individual refill.

Rotatable Nozzle (Block 202): A spray head capable of directional adjustment to control mist or stream dispersion.

Motorized Mechanism (Block 203): A servo or stepper motor enabling angular control of the nozzle.

Ink Injector (Block 204): An optional feed line that introduces invisible ink into the fluid stream prior to discharge.

Motion Sensor (Block 205): A detection module located near the canister to trigger spray when motion is detected.

Water Inlet (Block 206): A plumbing interface connecting the canister to an internal or external refill source.

Mounting Bracket/Base (Block 207): The robot bracket or base on which the fluid canister is mounted.

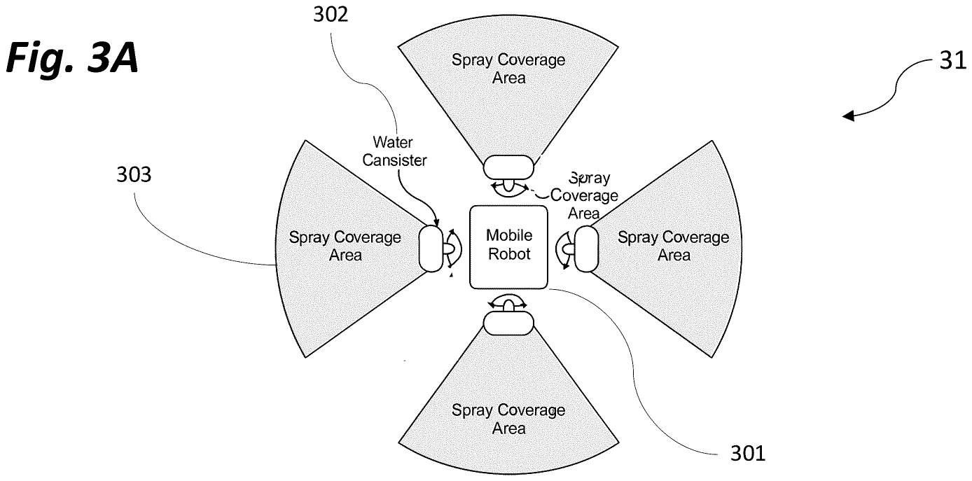

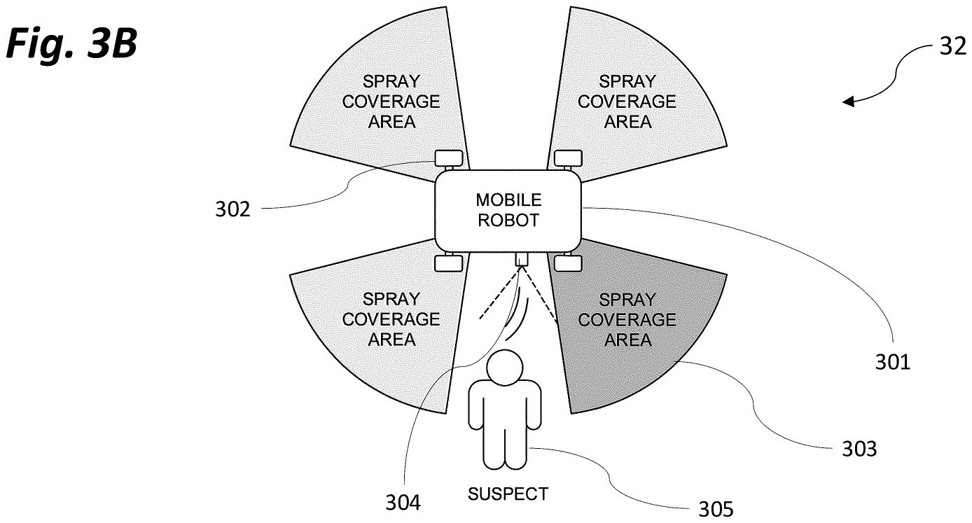

FIGS. 3a and 3b—Spray Coverage Patterns

FIG. 3A (Block 31) and 3B (Block 32) show top-down layouts of spray coverage patterns based on different canister mounting configurations.

Mobile Robot (Block 301): The base platform viewed from above.

Fluid Canisters (Block 302): Positioned either at the midpoints of the robot's four sides (FIG. 3A) or at its four corners (FIG. 3B).

Spray Coverage Area (Block 303): Arcs or cones representing each nozzle's spray radius.

Sensor Module (block 304): Included in FIG. 3b to Adjust Spray direction based on real-time detection.

Detected Suspect (Block 305): Also in FIG. 3B; shows the system dynamically responding by orienting spray coverage toward the individual.

Additional Detail: The rotating mechanism can be integrated with motion sensors or proximity detectors, enabling automatic targeting of nearby threats.

The system adjusts the spray direction in real-time to respond to the movement of individuals or objects.

### 2. Automated Refilling System

Operational behavior: The robot may autonomously identify low fluid levels and navigate to a designated refill station, following a pre-mapped route or dynamically generated path. Refill stations may be distributed across the robot's patrol zone to minimize downtime and extend operational coverage. Upon arrival, the robot may align with a docking interface and initiate the refilling process without requiring human intervention.

Additional detail: The refilling process may involve fluid level sensors and pumping mechanisms to ensure accurate replenishment while preventing overflows. The system can be configured to handle a variety of fluid sources, including external tanks, municipal water supplies, natural sources, or specialized refill cartridges. In some embodiments, the refilling process may also include flushing or sterilization steps to maintain fluid quality and system hygiene. To conserve onboard power, the refilling system may utilize dedicated pumps, passive siphon designs, or auxiliary energy inputs from the refill station.

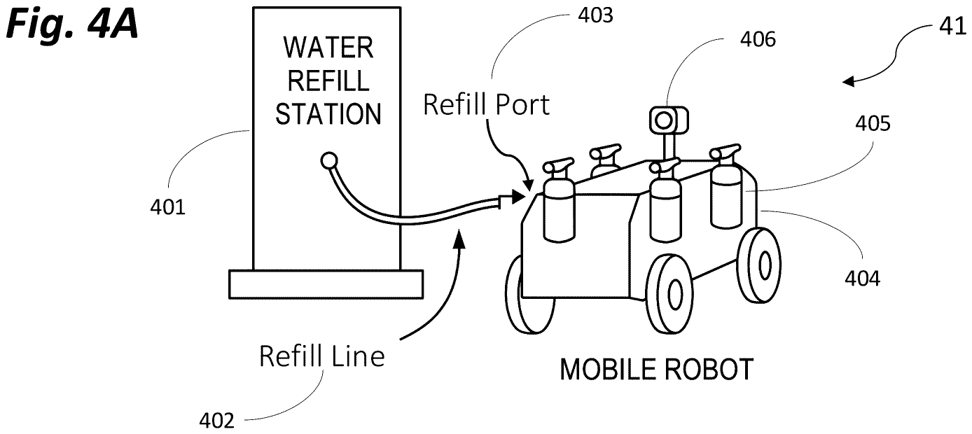

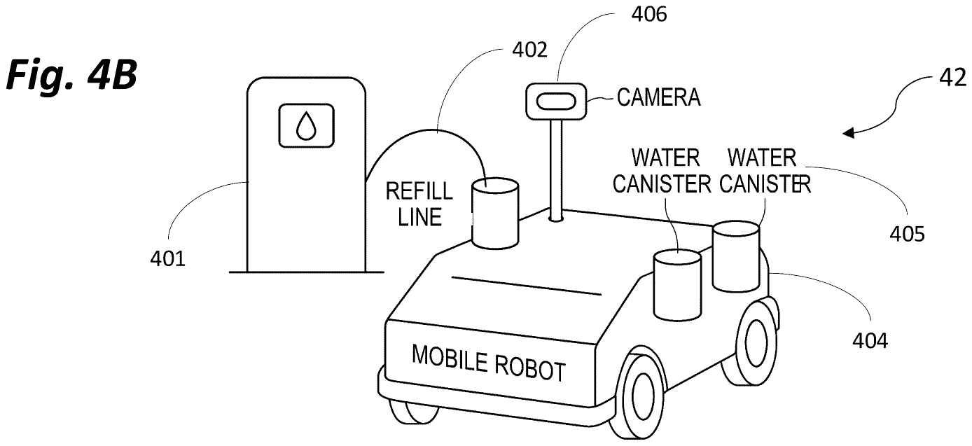

### FIGS. 4A and 4B—Refilling System

FIG. 4A (Block 41) and 4B (Block 42) depict two embodiments of the automated refilling system. FIG. 4A shows a centralized reservoir model, and FIG. 4B shows modular canister refilling.

Refill Station (Block 401): An external station containing a fluid reservoir and pumping mechanism.

Refill Line (Block 402): A flexible or fixed conduit for transferring fluid from the station to the robot.

Refill Port (Block 403): (FIG. 4A only)—A fluid entry point on the robot connected to an internal distribution system.

Mobile Robot (Block 404): The robot chassis that docks with the station for refilling.

Fluid Canister (Block 405): Internal or modular fluid containers that receive the transferred liquid.

Navigation/AI Sensors (Block 406): Cameras or LiDAR used for docking alignment.

### 3. Invisible Ink Application System:

An invisible ink application system may be integrated with the pressurized fluid canisters to covertly mark suspects or objects for future tracking. The ink may include UV-reactive compounds, IR-reflective compounds, or other formulations that become detectable under specific lighting or sensor conditions. In some embodiments, the ink may also include multi-spectral markers, thermal-reactive compounds, or other chemistries selected to meet operational requirements.

Additional detail: The invisible ink may be applied in a fine mist or targeted spray directed toward a suspect's clothing, vehicle, or carried object.

Activation may be triggered automatically by onboard sensors, semi-automatically by an operator's confirmation, or manually through direct operator control. Detection may be carried out using UV or IR handheld scanners, aerial platforms equipped with spectral sensors, or fixed cameras with appropriate filters. Law enforcement or security personnel may later use these detection methods to identify marked individuals or items, enabling delayed attribution and evidence gathering.

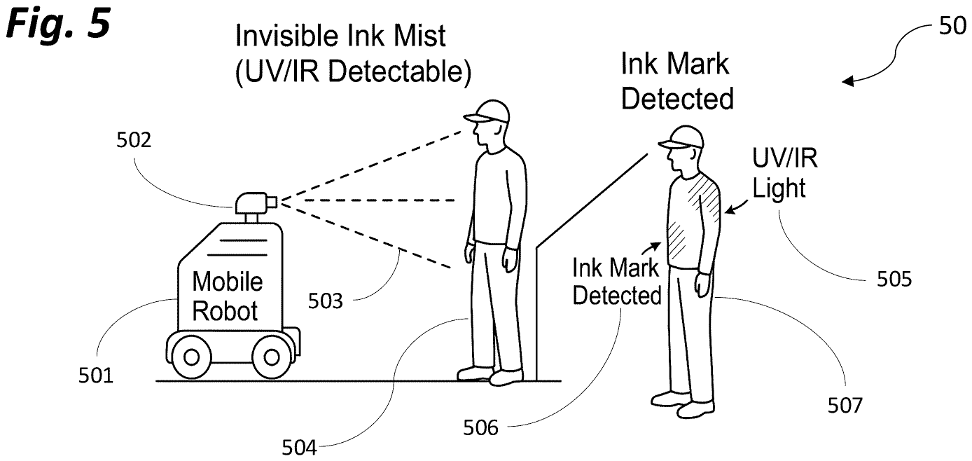

FIG. 5—I nvisible Ink Lifecycle

FIG. 5 (Block 50) shows the two-phase lifecycle of invisible ink marking: deployment during an incident and detection afterward.

Mobile Robot (Block 501): The robot platform with integrated ink-spray capabilities.

Spray Nozzle (Block 502): Dispenses the UV/IR-reactive ink.

Invisible Ink Mist (Block 503): The chemical marking fluid used for tagging.

Suspect-During Incident (Block 504): The individual or vehicle marked in real time.

UV/IR Light Source (Block 505): A scanning tool used for detection in the post-incident phase.

Detected Ink Mark (Block 506): The visible fluorescence or reflection revealing the marking.

Suspect-After Incident (Block 507): The same target identified later via scanning.

### 4. Sensor Integration:

To enhance activation control, the system incorporates various sensors such as proximity detectors, infrared sensors, or motion sensors to detect the presence of potential threats. These sensors trigger the activation of the fluid canisters when a threat is detected, ensuring rapid response and deterrence.

Additional Detail: In addition to motion sensors, advanced sensor systems like facial recognition or behavior analysis could be incorporated for more precise detection, further reducing the risk of false alarms and improving response times.

### 5. Rotating Mechanism:

Each pressurized fluid canister may be equipped with a rotating mechanism that allows for adjustable spray angles. The rotating mechanism may include one or more motorized actuators, such as servo motors, stepper motors, or other drive systems capable of providing directional control. The mechanism enables the robot to target specific areas or threats by adjusting the spray output in real time.

Additional detail: In some embodiments, the rotating mechanism may support continuous rotation to achieve 360-degree coverage, while in other embodiments, the rotation is limited to predefined angular ranges for simplified design. Rotation may be automatically adjusted based on sensor data or manually controlled through a user interface. In certain embodiments, the rotation is implemented at the nozzle level of each pressurized fluid canister, enabling directional adjustment of the spray output without rotating the entire canister or mounting assembly. This approach simplifies the mechanical design and reduces cost and maintenance requirements.

Because the mobile robot vehicle is capable of rotating its entire chassis in place, wide-angle coverage can also be achieved by combining chassis rotation with nozzle-level directional control. In some alternative embodiments, boundary-mounted rotating canisters or turret systems may be included to provide extended angular control when required.

### 6. Software Control System:

Additional detail: The software control system may include safety features such as remote override or emergency shut-off controls, allowing operators to deactivate the system when necessary. The control system may further incorporate real-time feedback mechanisms to monitor system status. Examples of such feedback include visual indicators (e.g., LEDs, displays, or projected signals), audible alerts (e.g., tones or synthesized speech), or wireless notifications to a remote device. These status outputs may provide information such as fluid levels, battery state, system health, and recent event logs. In some embodiments, the control system may also integrate with cloud-based or third-party platforms to enable remote monitoring, analytics, and compliance reporting.

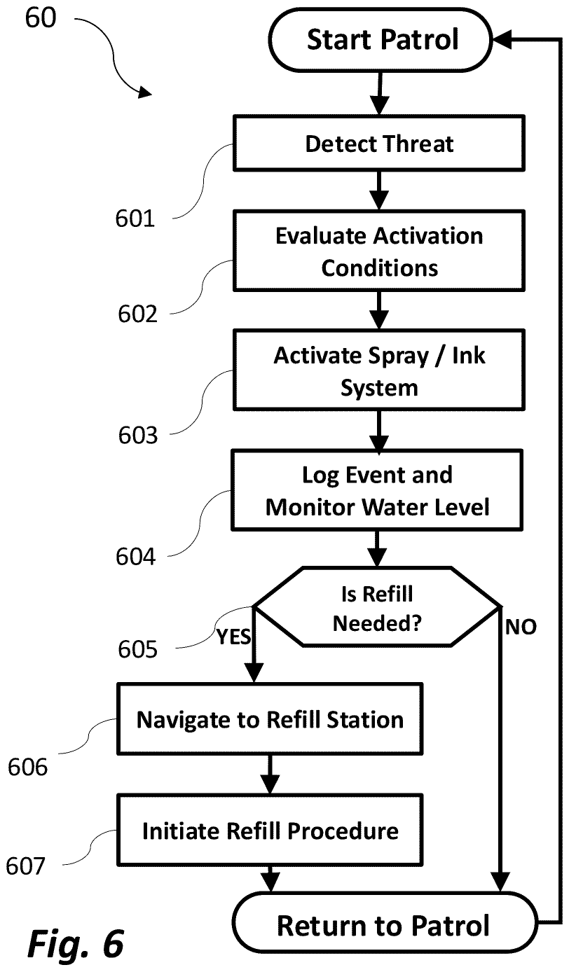

### FIG. 6—Operational Flowchart

FIG. 6 (Block 60) illustrates the logic flow of the robot's operation, including detection, spray deployment, logging, refilling, and patrol resumption.

Detect Threat (Block 601): Use of sensors to identify unauthorized activity.

Evaluate Activation (Block 602): Decision-making logic for determining spray response.

Activate Spray/Ink (Block 603): Triggering the deterrent mechanism.

Log Event (Block 604): Recording the incident and fluid usage.

Check Fluid Level (Block 605): Monitoring refill needs.

Navigate to Refill Station (Block 606): Movement to the docking station if refill is needed.

Initiate Refill (Block 607): Replenishment process.

Resume Patrol (Block 608): Return to standard operation.

### 7. Maintenance and Refilling:

The automated refilling system ensures that the fluid canisters remain operational throughout the robot's deployment. When fluid levels fall below a predetermined threshold, the robot automatically activates the refilling process, either through direct access to a built-in fluid tank or by docking at a refill station.

Additional Detail: The refilling process involves both fluid level sensors and pumping mechanisms to ensure that the canisters are filled in a controlled manner, preventing overflows or damage. This system can be configured to handle different types of fluid sources, including external tanks, municipal water supplies, natural sources, or specialized refill cartridges.

Power and Durability Considerations: the Refilling System Is designed to operate without draining the robot's primary power supply. It is built with durability in mind, incorporating weatherproof materials to ensure reliable performance in various environmental conditions.

### 8. Agricultural and Environmental Applications

In an alternative set of embodiments, the robotic spraying system may be repurposed for agricultural, environmental, or facility-management use cases. The mobile robot vehicle may be configured to irrigate vegetation such as fruit trees, crops, landscaped lawns, or golf course turf. Environmental sensors-including soil moisture probes, temperature sensors, or spectral imaging devices-may be mounted on the robot to assess plant hydration needs and dynamically guide spray routines.

In some embodiments, the system may be used to cool domesticated animals such as cattle, horses, or zoo animals during high-temperature conditions. Spray routines may be activated on a schedule, in response to environmental thresholds, or under remote operator control.

In still other embodiments, the system may serve as a humane wildlife deterrent by detecting and spraying wild animals (e.g., raccoons, deer, coyotes, or birds) that enter predefined exclusion zones. Object-classification software may distinguish wild animals from pets, humans, or vehicles, enabling species-specific responses. Fluids may include plain water for hydration, or harmless deterrent mixtures for wildlife control.

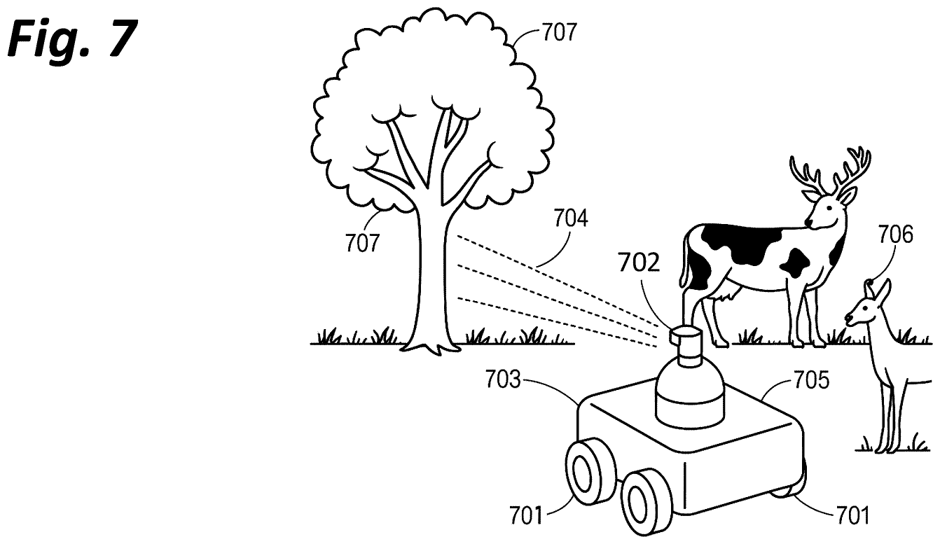

FIG. 7 (Block 70) illustrates an embodiment of the robotic spraying system deployed in an outdoor agricultural or residential setting, including vegetation hydration, animal cooling, and wildlife deterrence.

FIG. 7—A gricultural/Environmental Use Case

FIG. 7 (Block 70) presents an alternative use of the system in agricultural or environmental settings, supporting hydration, cooling, or wildlife deterrence.

Robot Vehicle (Block 701): The autonomous chassis deployed in non-security environments.

Spray Nozzles (Block 702): Configured for wide-area or targeted spraying of plants or animals.

Soil/Plant Sensor (Block 703): Detects dryness or hydration needs.

Environmental Detector (Block 704): Identifies nearby animals or wildlife.

Control System (Block 705): Governs spray routines based on classification and environment.

Domestic or Wild Animal (Block 706): Subject of cooling or deterrence spray.

Vegetation or Tree (Block 707): Target for hydration spraying.

Fluid reservoirs may be loaded with plain water for hydration, or with harmless, scent-based deterrent mixtures in wildlife control scenarios. The robot's navigation system may optimize coverage areas based on mapped vegetation zones, animal pathways, or farm infrastructure.

### Additional Considerations:

The security robot system may be implemented with various design principles to ensure safe and reliable operation. Weight distribution and balance may be managed so that the addition of fluid canisters, rotating mechanisms, or auxiliary modules does not compromise stability or maneuverability. Safety features may include compliance with regulations for operating pressurized systems, safeguards against unintended discharge, and responsible use of deterrent substances.

Durability may be achieved by using weather-resistant housings, corrosion-resistant plumbing, and reinforced structural components, allowing the system to perform in diverse outdoor environments. Environmental adaptability may further include operation under rain, dust, heat, or cold conditions. In some embodiments, modular construction may be used to facilitate maintenance, upgrades, and replacement of consumable components.

These design considerations may be adapted depending on whether the system is deployed in security, agricultural, or environmental settings, ensuring broad applicability across multiple domains.

The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A modular fluid canister unit for use with an autonomous security robot, the unit comprising:
a pressurized container configured to store a fluid for deterrence or environmental use;
a rotatable nozzle assembly mounted at a portion of the pressurized container, the nozzle configured to emit a spray in a direction adjustable by rotation;
a motorized rotation mechanism operatively coupled to the nozzle assembly, the mechanism comprising at least one of a servo motor, stepper motor, or other actuator configured to control directional spray;
a sensor integrated with the canister unit, the sensor configured to detect nearby activity within a predefined coverage arc;
an optional injector configured to introduce ultraviolet-reactive, infrared-reactive, or other detectable ink into the fluid stream prior to emission; and
a connector interface configured for attachment to a robot chassis, the interface providing at least one of structural support, power transfer, or fluid input/output.

2. The modular fluid canister unit of claim 1, wherein the nozzle assembly is configurable between multiple spray modes including a mist mode for wide-area coverage and a stream mode for targeted deterrence.

3. The modular fluid canister unit of claim 1, wherein the sensor is positioned adjacent to the nozzle and configured to trigger spray activation when a target enters a detection field ranging from 60 to 120 degrees.

4. The modular fluid canister unit of claim 1, wherein the injector comprises a fluid line coupled to an ink reservoir and a mixing junction located upstream of the nozzle.

5. The modular fluid canister unit of claim 1, wherein the connector interface comprises at least one mechanical coupling, at least one electrical connector, and at least one fluid conduit, the electrical connector configured to transfer both power and control signals between the unit and the robot, and the fluid conduit configured to enable automated refilling or pressurization of the canister without manual intervention.

6. The modular fluid canister unit of claim 1, wherein the pressurized container is constructed from a weather-resistant composite material configured to withstand outdoor environmental conditions including heat, moisture, and physical impact.

7. The modular fluid canister unit of claim 1, wherein the unit is configured for hot-swapping, such that the canister can be removed and replaced with a substitute canister while the robot remains powered on and operational, without requiring system reboot or depressurization of unrelated canisters.

8. The modular fluid canister unit of claim 1, further comprising a pressure relief valve integrated with the pressurized container and configured to automatically vent excess pressure to prevent rupture.

9. The modular fluid canister unit of claim 1, further comprising at least one sensor selected from the group consisting of a fluid level sensor, a pressure sensor, a temperature sensor, and a leak detection sensor, each configured to transmit data to the robot's control system.

10. The modular fluid canister unit of claim 1, wherein the canister is secured by a quick-release latch mechanism enabling manual replacement in less than five seconds.

11. The modular fluid canister unit of claim 1, wherein the canister includes an exterior protective casing made of impact-resistant or ballistic-resistant material to reduce risk of damage during hostile encounters.

12. The modular fluid canister unit of claim 1, wherein the connector interface is configured to align with a docking port of a refill station using mechanical guide rails or magnetic alignment features.

13. The modular fluid canister unit of claim 1, wherein the fluid conduit of the connector interface includes an automated sealing mechanism that prevents leakage during docking and undocking.

14. The modular fluid canister unit of claim 1, wherein the unit further comprises an identification tag selected from the group consisting of RFID, QR code, or NFC, enabling the refill station to verify compatibility prior to fluid transfer.

15. The modular fluid canister unit of claim 1, wherein multiple units are configured to dock simultaneously with a common refill manifold to enable batch refilling of a plurality of canisters.

16. The modular fluid canister unit of claim 1, wherein the refill process is initiated by the robot's control system sending a wireless command to the refill station to begin fluid transfer upon alignment.

17. The modular fluid canister unit of claim 1, wherein the canister is configured to store and dispense a fire-suppressant fluid selected from the group consisting of water mist, foam concentrate, or inert gas.

18. The modular fluid canister unit of claim 1, wherein the canister is configured to store and dispense a marking fluid comprising at least one of a permanent dye, a pigment, a fluorescent tracer, or a chemical identifier, the marking fluid being adapted to visually or chemically identify a suspect or object for subsequent tracking and investigation.

19. The modular fluid canister unit of claim 1, wherein the canister is configured to store and dispense a medical fluid selected from the group consisting of saline solution, disinfectant, or an aerosolized first-aid composition, the medical fluid being adapted to provide emergency hydration, wound cleansing, or localized disinfection in response to a detected incident.

20. A method of replacing a modular fluid canister unit on a mobile security robot, the method comprising:
removing a first modular fluid canister unit from a connector interface of the robot while the robot remains powered on;
aligning a second modular fluid canister unit with the connector interface using at least one of a mechanical guide rail, a magnetic alignment feature, or a quick-release latch;
engaging the connector interface to establish at least one of a fluid conduit, an electrical connection, and a control signal path between the second unit and the robot; and
initiating fluid availability by verifying a successful connection through the robot's control system without requiring a system reboot or depressurization of other canisters.
